(19) United States
(12) Patent Application Publication
(10) Pub. No.: US 2017/0368380 A1
(43) Pub. Date: Dec. 28, 2017

(54) METHOD OF PURIFYING AIR FOR INHALATION AND SYSTEM FOR PURIFYING AIR FOR INHALATION

(71) Applicant: BLUEAIR AB, STOCKHOLM (SE)

(72) Inventor: Bengt Rittri, STOCKHOLM (SE)

(21) Appl. No.: 15/538,919

(22) PCT Filed: Dec. 12, 2015
(86) PCT No.: PCT/EP2015/080992

§ 371 Date: Jun. 22, 2017

(30) Foreign Application Priority Data
Dec. 23, 2014 (EP) 14199977.1

(51) Int. Cl. A62B 7/10; A62B 23/02

(52) U.S. Cl. CPC A62B 7/10; A62B 23/025

(57) ABSTRACT

A method of purifying air for inhalation. The method includes the steps: use of an ionizing device, electrically charging airborne particles; outputting the charged airborne particles, and filtering air through a filter included in a respiratory mask worn by a user present, wherein the filter includes filter fibers of a material attracting at least some of the charged airborne particles. A related system for purifying air for inhalation is also provided.

### FIELD OF THE INVENTION

The present invention generally relates to the field of purifying air.

### BACKGROUND OF THE INVENTION

Different types of air purifying devices are frequently used for cleaning air from pollutants. For example stationary devices are arranged in areas or buildings in geographical areas where the surrounding air contains a high amount of particles that could affect people exposed to the particles and/or processes performed in this environment. Especially in larger cities, where e.g. traffic congestions sometimes may severely reduce the quality of the air, people often feel a need for air purificaton to protect themselves from inhaling smog or other forms of aerial pollutions, or within areas where different types of work or processes generating polutants spread in the surrounding air are located.

The need for air purificatoin is even higher within for example the food industry, the process industry and hospitals etc located in these areas since airborn particles could have severe impact on the final result of the product, process or the patients after treatment/surgerey etc.

One commonly used type of air purifying devices is stationary arranged devices comprising a ionizier that electrically charges particles in the air before the air is lead via a filter adapted to extract the ionizied particles from the air flowing through the filter.

Even though different types of air purifying devices are available on the market today there is still a need for improved methods for purifying air, as well as air purifying systems that ensures that hazardous particles are extracted from the air to ensure the desired purification.

### SUMMARY OF THE INVENTION

The present invention presents a method for purifying air for inhalation and a system for purifying air for inhalation that to at least some extent fullfills the needs defined above. This is achieved by providing increased purification, i.e. reduce the amount of contaminated particles in air for inhalation.

The method for purifying air for inhalation comprises the steps:
by means of an ionizing device, electrically charging airborne particles,
outputting the charged airborne particles, and
filtering air through a filter comprised in a respiratory mask worn by a user present, wherein the filter comprises filter fibers of a material attracting at least some of the charged airborne particles.

The claimed method is very advantageous since one or more ionizing devices are arranged in for example a building, within a partly defined space alternatively close to the user to increase the amount of jonized particles in the air surrounding the user. The increased amount of jonized particles in the close surrounding of the user in combination with the filter in the respiratory mask will provide a very high level of purification in the air inhaled via the respiratory mask.

Air purification using the claimed method provides a flexible system since the ionizing device is arranged separately from the filter which reduces the size and weight compared to the existing stationary air purification devices still providing a very high level of purification of the inhaled air since the user benefits from the advantage that all inhaled air has passed the filter in the respiratory mask. The fact that all inhaled air is lead via the filter in the respiratory mask where the ionizied particles are separated from the air further increases the amount of pollutions that is extracted from the air.

Respiratory masks are commonly used to reduce the spread of infectious diseases, both to protect the wearer of the mask from getting infected and to keep the wearer from spreading airborn particles. Consequently, the claimed method and system provides an excellent combinations since the ionization device and the filter in the mask provides purified air for inhalation and prevents spread of airborn particles.

In one embodiment of the method, the filter fibers are made of a dielectric material. Filter fibres of dielectric material are very efficient for purification of air with ionizied particles since the dielectric fibers will attract the ionizied particles that remain in the filter. Due to the efficient extraction of particles in the filter, the filter could be designed to have limited impact on the flow of air through the filter. This is very important since the limited impact on the flow of air through the filter is of major importance to be able to provide enough air via the filter to the user and ensure that the user is able to to breath properly.

In one embodiment of the method, the filter comprises filter fibers being pre-charged. Filters made of a pre-charged filter material are very efficient for purifying air comprising ionized particles since the pr-charged fibers will attract the ionized particles and prevent them from being inhaled by the user.

In one embodiment of the method, the filter comprises dielectric filter fibers being non-pre-charged. Filters made of dielectric non-precharged fibers have proven to be very efficient for a long period of time. This is very beneficial compared to pre-charged filter materials especially if the filter may be stored before it is used since the aging process starts immediately when the filter is produced.

In one embodiment of the method, the ionizing device and user are located within a confined space, such as a room. Using the claimed method and system in a confined space ensures that the desired level of ionized particles is reached which is required to achieve the desired purification of the air inhalation air.

In one embodiment of the method, the ionizing device is located at a maximum of 15 m, and preferably at a maximum of 10 m, from the user in the confined space. The specified distances increase the possibility to reach and maintain the desired ionization levels and consequently the desired purification of the inhalation air.

In one embodiment of the method, the ionizing device and user are located at a maximum distance from each other of 2 meters, and preferably less than 1.5 meter. If the distance between the ionization device and the user is within the defined range, the desired ionization levels could be reached without the confined space. This is very advantageous since the method and system according to this embodiment could be used outside confined spaces, or arranged at a smaller work station.

In one embodiment of the method, the time it takes for the charged particles to travel from the ionizing device to the respiratory mask is less than 300 s.

In one embodiment of the method, the concentration of charged airborne particles in the air passing through the respiratory mask is at least 30 000 ions/cm³

In one embodiment of the method, the air including the airborne particles to be ionized by the ionizing device is circulating within the confined space. This is advantageous since the circulation ensures that particles in the air will pass the ionization device where the particles are ionized and distributed within the entire volume within the confined space and uses experience the same possibilities to inhale purified air no matter the position within the confined space.

In one embodiment of the method, the air to be ionized by the ionizing device is drawn from outside the confined space. If the confined space is provided with an arrangement for supplying air from outside the confined space to the confined space, the ionization device is preferably arranged in or close to the air flowing into the confined space to ensure the desired ionization level in the confined space.

In one embodiment of the method, the ionizer device is stationary arranged in the confined space or close to the expected position or prepared work space for the user.

As mentioned above, the invention also relates to a system for purifying air for inhalation. The system comprises:

an ionizing device arranged to electrically charge airborne particles, and

at least one respiratory mask worn by a user, the respiratory mask comprising a filter arranged to filter air to be inhaled by the user, wherein the filter comprises filter fibers of a material adapted to attract the charged airborne particles.

It is noted that embodiments of the invention relates to all possible combinations of features recited in the claims. Further, it will be appreciated that the various embodiments described for the method are all combinable with the system as defined in accordance with the second aspect of the present invention.

### BRIEF DESCRIPTION OF THE DRAWINGS

The invention, and other aspects, will now be described in more detail in the following illustrative and non-limiting detailed description of embodiments, with reference to the appended drawings.

FIG. 1 is a schematic illustration of the system according to the invention implemented in a confined space.

FIG. 2 is a schematic illustration of the ionization device arranged within a shorter distance from the user.

FIG. 3 is a schematic illustration of a respiration mask in the correct position on the user.

All the figures are schematic, not necessarily to scale, and generally only disclosing parts which are necessary in order to elucidate the embodiments, wherein other parts may be omitted. Like reference numerals refer to like elements throughout the description.

### DETAILED DESCRIPTION OF EMBODIMENTS

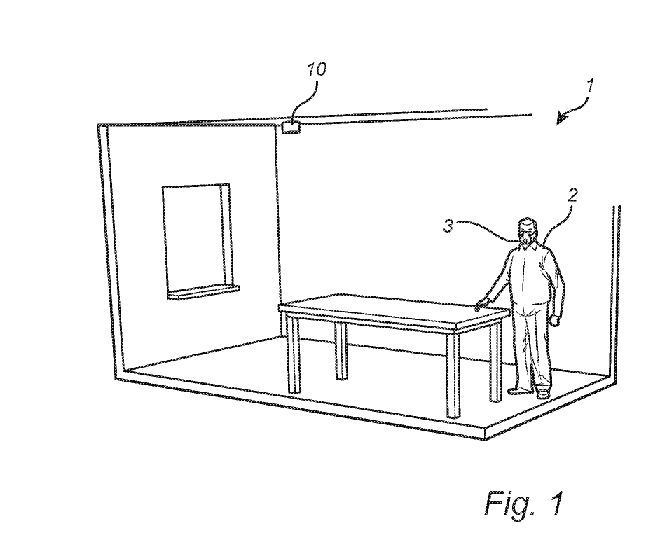

A first embodiment of the system according to the invention is described with reference to FIG. 1. The system illustrated in FIG. 1 is intended for use within a confined space, i.e. a substantially cuboidal room 1. The design/shape and size of the room could however be modified in many ways since the shape/design of the space affect the function of the system. Depending on the size and design of the room, one, or more, ionizing devices 10 are arranged within the room. The illustrated system comprises one ionizing device 10 arranged close to the sealing and one of the corners of the confined space but the position could be anywhere within the room as long as the ionizing device not is covered or blocked by furniture or other equipment that are interfering with the flow of air past the ionizing device.

The ionizing device 10 is ionizing air borne particles in the air surrounding the device 10. Preferably the air in the confined space is at least to some extent circulating within the space to improve the ionization level within the entire space. In the ionizing device 10 a high voltage is applied on one or more conductors, for example needles or a carbon fiber brush, to electrically charge air borne particles close to the conductor. This technique is well known in the art and often referred to as “corona discharging” for ionizing of particles.

In FIG. 1, a user 2 wearing a respiratory mask 3 is illustrated. The respiratory mask could be designed in many different ways but must contain a nose and mouth covering element 4 to ensure that all inhaled air is passing a filter 5 fitted in the mask. The element is held in the correct place on the user by one or more adjustable straps 7 extending around the head of the user. The filter 5 is arranged close to the nose and mouth to ensure that the flow of air through the filter could be maintained without more limitations than necessary for the user. The air is lead to the filter via a filter inlet 6 and the filter area must be large enough to ensure that enough air is fed to the user. The mask 3 is preferably designed to be comfortable for the user to wear and made of a material providing the desired strength, appearance and weight.

The filter 5 fitted in the mask is made of a material that is able to bound the ionizied particles in the air passing through the filter to reduce the amount of particles that are inhaled by the user. Different types of filter fibres could be used depending on the expected type of particles in the air that needs to be purified. The filter is preferably removably secured in the respiratory mark to make it possible to replace the filter by another type of filter, or a new fresh filter after the expected life-time of the filter has been passed.

The filter comprises filter fibers of a material attracting the charged airborne particles. Different types of fiber materials could be used such as dielectric fibers, precharged fibers or non-precharged fibers each having different characteristics and weaknesses.

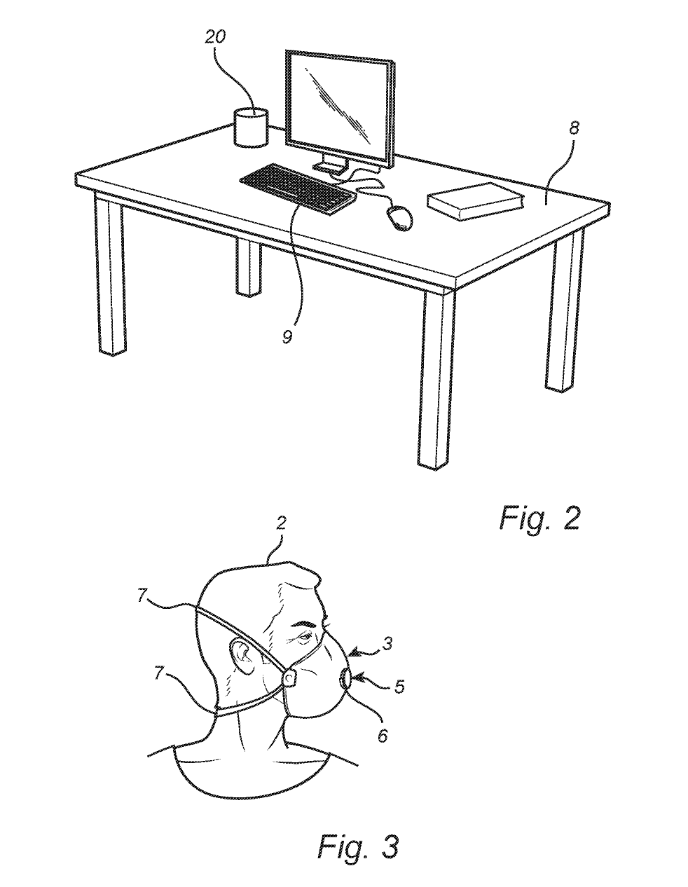

A second embodiment of the system according to the invention is described with reference to FIG. 2. The system comprises the same components, an ionization device and a respiratory mask, and operates according to the same method but the ionization device is configured differently. The ionizing device 20 is in this embodiment positioned within a much smaller distance from the user, for example on the surface of a work station 8 close to the intended position 9 of the user as illustrated in FIG. 2. The user, not illustrated in FIG. 2, is wearing the same type or respiratory mask 3 as described above. The short distance between the ionization device 20 and the filter in the mask 3 eliminates the need for a confined space to ensure the desired level of ionizied particles around the filter inlet is reached.

The person skilled in the art realizes that the present invention by no means is limited to the embodiments described above. On the contrary, many modifications and variations are possible within the scope of the appended claims. For example, in a further embodiment, not illustrated in the figures, the ionization device is arranged on the user that for example is carrying the ionization device on the back, chest alternatively hanging in a strap around the neck of the user. In this embodiment the distance between the ionization device and the filter inlet is reduced even further. This embodiment is favourable since the user will be able to move within larger areas compared to the embodiments where the ionization device is stationary arranged.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1-17. (canceled)

18. A method of purifying air for inhalation, the method comprising:
by means of an ionizing device, electrically charging airborne particles,
outputting the charged airborne particles, and
filtering air through a filter comprised in a respiratory mask worn by a user present, wherein the ionizing device and user are located within a confined space, such as a room, and the filter comprises filter fibers of a material attracting at least some of the charged airborne particles.

19. The method as defined in claim 18, wherein the filter fibers are made of a dielectric material.

20. The method as defined in claim 18, wherein the filter comprises filter fibers being pre-charged.

21. The method as defined in claim 18, wherein the filter comprises filter fibers being non-pre-charged.

22. The method as defined in claim 18, wherein the ionizing device is located at a maximum of 15 meters from the user in the confined space.

23. The method as defined in claim 22, wherein the ionizing device is located at a maximum of 10 meters from the user in the confined space.

24. The method as defined in claim 18, wherein the ionizing device and user are located at a maximum distance from each other of 2 meters.

25. The method as defined in claim 24, wherein the ionizing device and user are located at a maximum distance from each other of 1.5 meters.

26. The method as defined in claim 18, wherein the time it takes for the charged particles to travel from the ionizing device to the respiratory mask is less than 300 seconds.

27. The method as defined in claim 18, wherein the concentration of charged airborne particles in the air passing through the filter in the respiratory mask is at least 30,000 ions/cm³.

28. The method as defined in claim 18, wherein the air including the airborne particles to be ionized by the ionizing device is circulating within the confined space.

29. The method as defined in claim 18, wherein the air to be ionized by the ionizing device is drawn from outside the confined space.

30. The method as defined in claim 18, wherein the ionizer device is stationary arranged.

31. System for purifying air for inhalation, the system comprising:
an ionizing device arranged to electrically charge airborne particles, and
at least one respiratory mask worn by a user, the respiratory mask comprising a filter arranged to filter air to be inhaled by the user, wherein the ionizing device and user are located within a confined space, such as a room, and the filter comprises filter fibers of a material adapted to attract the charged airborne particles.

32. The system according to claim 31, wherein the filter is made of fibers of a dielectric material.

33. The system according to claim 31, wherein the ionizing device is located at a maximum of 15 meters from the user in the confined space.

34. The system according to claim 33, wherein the ionizing device is located at a maximum of 10 meters from the user in the confined space.

35. The system according to claim 31, wherein the ionizing device and user are located at a maximum distance from each other of 2 meters.

36. The system according to claim 35, wherein the ionizing device and user are located at a maximum distance from each other of 1.5 meters.
